(19) United States
(12) Patent Application Publication
(10) Pub. No.: US 2018/0029254 A1
(43) Pub. Date: Feb. 1, 2018

(54) DEVICE FOR IRRADIATING A CYLINDRICAL SUBSTRATE

(71) Applicant: Heraeus Noblelight GmbH, Hanau (DE)

(72) Inventors: Lotta GAAB, Darmstadt (DE); Christian POPPE, Steinfurt (DE); Sven LINOW, Darmstadt (DE)

(21) Appl. No.: 15/547,843

(22) PCT Filed: Dec. 11, 2015
(86) PCT No.: PCT/EP2015/079380

§ 371 Date: Aug. 1, 2017

(30) Foreign Application Priority Data
Feb. 3, 2015 (DE) 10 2015 101 511.0

(51) Int. Cl. B29C 35/08

(52) U.S. Cl. CPC B29C 35/08; B29C 2035/0822

(57) ABSTRACT

Known devices for irradiating a cylindrical substrate have a cylindrical irradiation chamber having a center axis, and a radiator unit around the irradiation chamber. Starting from these known devices, to provide a device that can be easily and quickly retrofitted and also enables a uniform irradiation of the substrate, it is proposed according to the invention that the radiator unit be formed from multiple segments connected to each other, wherein each of the segments has an optical main radiator having an illuminated radiator tube section that is curved outwardly with respect to the center axis, and wherein the radiator tube sections are arranged in a common radiator plane perpendicular to the center axis.

### CROSS-REFERENCE TO RELATED APPLICATIONS

This application is a Section 371 of International Application No. PCT/EP2015/079380, filed Dec. 11, 2015, which was published in the German language on Aug. 11, 2016, under International Publication No. WO 2016/124279 A1 and the disclosure of which is incorporated herein by reference.

### BACKGROUND OF THE INVENTION

The present invention relates to a device for irradiating a cylindrical substrate, wherein this device comprises a cylindrical irradiation chamber having a center axis and a radiator unit around the irradiation chamber.

The present invention further relates to a segment for use in a device for irradiating a cylindrical substrate.

Such devices are used, in particular, for irradiating cord-shaped substrates, for example for the processing of fibers or threads to form fiber composite materials. They can be used, in particular, for the production of pultruded fiber composite profiles.

Known devices that are used for irradiating elongated, cylindrical substrates often have a structural shape adapted to the shape of the substrate. They comprise a cylindrical irradiation chamber and a radiation source for irradiating a substrate located in the irradiation chamber.

In these devices, the substrate to be irradiated is often fed continuously to the irradiation chamber. Typical irradiation devices therefore have passage openings for feeding the substrate into the devices. The substrate is here fed into the irradiation chamber through one transverse side of the cylindrical irradiation chamber, irradiated in the irradiation chamber, and is finally fed out of the irradiation chamber on the opposite transverse side. The radiation source can be radiators having different emission spectra, for example infrared radiators or UV radiators. The most uniform heating of the substrate possible is enabled when the radiation source has an annular radiator tube and the substrate is fed into a middle area of the radiator tube ring.

An irradiation device of the class specified above is known from DE 10 2011 017 328 A1. This irradiation device can be used for the processing of threads to form a fiber composite. For producing the fiber composite, it is necessary to heat the threads in a contact area in advance. To enable a uniform heating of the threads, these are fed through a heating zone that is formed by multiple ring-shaped infrared radiators. Such radiators are also called omega radiators, and they extend around the substrate to be irradiated.

Ring-shaped radiators have the disadvantage that they cannot be opened. This makes it more difficult to access the substrate, especially for maintenance and repair work. In addition, when changing to a different production process, the radiation output of the ring radiator can be varied and adapted to the new production process only to a limited degree; consequently, their scaling capabilities are poor. For the reasons named above, it is complicated to replace the annular radiator. In addition, a series arrangement of ring-shaped radiators has structural disadvantages. This is especially true when the space available for the positioning of ring-shaped radiators is limited, narrow, or difficult to access.

### BRIEF SUMMARY OF THE INVENTION

The invention is therefore based on the object of providing an irradiation device for irradiating cylindrical substrates, which can be easily and quickly retrofitted and that also allows a uniform irradiation of the substrate.

The invention is further based on the object of providing a segment that can be used in an irradiation device and enables a homogeneous heating of the substrate.

With respect to the irradiation device, this object is achieved according to the invention starting from a device of the type mentioned above, such that the radiator unit is formed from multiple segments connected to each other, wherein each of the segments has an optical main radiator having an illuminated radiator tube section that is curved outwardly with respect to the center axis, and wherein the radiator tube sections are arranged in a common radiator plane perpendicular to the center axis.

The irradiation device is designed for the uniform irradiation of cylindrical substrates. Cylindrical substrates are elongated, for example cord-shaped, substrates that have a relatively small diameter compared with their length; they have a substrate longitudinal axis. To be able to irradiate and then process such substrates in a continuous process, a uniform irradiation in an irradiation plane perpendicular to the substrate longitudinal axis is desired.

The requirements for the homogeneity of the irradiation are especially high, for example, if the substrate to be irradiated and to be heated itself has low thermal conductivity, because for such substrates, a non-uniform irradiation can be compensated only to a limited degree by thermal conduction in the substrate. Consequently, temperature differences are observed in the substrate. Substrates having low thermal conductivity are, for example, ceramics, plastics, fiber-reinforced plastics with fibers of glass, carbon, or basalt, and a matrix made of thermosetting plastics or thermoplastics, especially made of polyamide (PA), polypropylene (PP), or polystyrene (PS).

However, in other methods, as for example the curing of coatings on cylindrical substrates, a uniform irradiation intensity with respect to the periphery of the substrate is an important prerequisite for the production of high-quality irradiation products.

A uniform irradiation can indeed be achieved by the use of ring-shaped radiators, but these have the disadvantage, on one hand, that they cannot be opened and, on the other hand, their radiation output and emission spectrum can be adapted to a different substrate only to a very limited degree. Therefore, when the substrate is changed, it is often necessary to replace the ring-shaped radiator. This is difficult and time-consuming, however, due to the closed construction.

According to the invention it is therefore provided that the radiator unit have a modular structure made of multiple circular segments. Each of the segments has at least one main radiator. They can be assembled to form a quasi-ring-shaped radiator complex. The segments can have an identical structure or can be different. For example, the segments can differ in their main radiators, their radiation output, or the emitted radiation spectrum. Due to their modular design, the segments can be removed arbitrarily from the radiator unit, replaced by other segments, or reinstalled. They enable, in particular, a variable setup of the radiator unit or the setting of a special radiation output or a special emission spectrum. Therefore, they are suitable for a quick adaptation of the radiator unit to a changed irradiation process or a changed substrate to be irradiated. At the same time, this enables a quick and simple maintenance of the irradiation device.

Therefore, because each of the segments has an optical main radiator having an illuminated radiator tube section that is curved outward viewed from the center axis out, it is possible for the distance of the substrate surface from the radiator tube of the main radiator to be as uniform as possible. A distance that is as uniform as possible is associated with a uniform irradiation of the substrate. A radiator tube curved outward about the center axis is a good approximation for different cross-sectional shapes of the cylindrical substrate. The term “cylindrical” is not limited, both with reference to the substrate and also with respect to the irradiation chamber, to shapes having a circular round cross section. It also comprises different cross-sectional shapes, for example oval, rectangular, square, or polygonal cross-sectional shapes. Especially good results with respect to a uniform irradiation of the substrate can be achieved when the curvature of the illuminated radiator tube section is adapted to the cross-sectional shape of the substrate to be irradiated.

In contrast to a polygonal arrangement of multiple elongated radiators having straight radiator tubes around the irradiation chamber, the provision of curved radiators has, on one hand, the advantage that the distances of the substrate to the radiator tubes are as uniform as possible and have smaller deviations. Indeed, an approximation of the ring shape can be achieved by providing a large number of radiators, but here it is to be taken into consideration that a ring-shaped arrangement of multiple radiators is associated with lower energy efficiency. In addition, for these radiators, the area of the radiator tube ends is regularly not illuminated. This has the result that the substrate is alternately surrounded by illuminated and non-illuminated sections, which negatively affects a uniform irradiation of the substrate.

Therefore, because according to the invention the radiator tube sections of the multiple segments are arranged in a common radiator plane running perpendicular to the center axis, with respect to the substrate, an all-around uniform irradiation of the substrate is ensured.

In one advantageous construction of the device according to the invention, it is provided that between the illuminated radiator tube sections of adjacent segments, an optical secondary radiator is arranged. The main radiator of each segment has one illuminated and at least one non-illuminated radiator tube section. To enable a uniform irradiation, the illuminated radiator tube sections of adjacent segments are guided as close to each other as possible, for example such that the radiator tubes of the transition area are angled from the illuminated radiator tube section to the non-illuminated radiator tube section. However, the illuminated radiator tube sections of the adjacent main radiator then do not directly abut each other. In this way, in the segment connecting points, regularly lower irradiation intensities are achieved than in a central section of the illuminated radiator tube section, which can negatively affect the uniformity of the irradiation.

In order to nevertheless ensure the most homogeneous irradiation of the substrate possible, in areas of low irradiation intensity, there is at least one secondary radiator that compensates for the drop in intensity of the main radiator in these areas. The minimum number of secondary radiators thus corresponds to the number of segments. Secondary radiators can be point radiators or spot radiators, for example. They can be controlled either together with or independently from the main radiators.

It has proven especially effective if the irradiation device has a regulation/control device with which the output of the secondary radiator can be adjusted as a function of the output of the main radiator (master-slave concept). In this way, a simple and quick adaptation of the irradiation intensity to different substrates is made possible by adjusting the radiation output of the main radiator, without requiring a separate adjustment of the output of the secondary radiator. In this connection, it has proven further effective if the irradiation device has a means for detecting a process variable, wherein the radiation output of the main and/or secondary radiators is set as a function of the detected process variable. A suitable process variable is, for example, the temperature of the substrate.

It has also proven effective that, when the substrate is fed continuously to the irradiation chamber, means for detecting the advance rate of the substrate are provided and that the regulation/control of the output of the main and/or secondary radiators is realized by the regulation/control device as a function of the advance rate.

It has proven effective if each of the segments has a first and a second end for the detachable connection to an adjacent segment, and if the secondary radiator is arranged at the first end.

Segments that can be connected detachably to each other can be assembled quickly and easily. This applies especially when the assembled segments form a ring-shaped radiator unit. In this way, individual segments can be removed from the radiator unit or replaced. Advantageously, the detachable connection is constructed so that it is not necessary to use a tool to create and/or detach the connection. Each segment is here equipped with the at least one secondary radiator that is mounted together with the segment and whose power supply and control is realized via the segment in question.

Therefore, because the segments have two ends for connecting to an adjacent element, it is possible to link a plurality of segments to each other. In the simplest case, however, two elements are connected to each other while forming an essentially ring-shaped structure.

In particular, at the connecting points of adjacent segments, lower irradiation intensities can occur in comparison to a central area of the illuminated radiator tube section of the main radiator, which are completely or partially compensated by the secondary radiator in the area of the connection of adjacent segments. Therefore, because the secondary radiator is arranged at one end of the segment, in the adjacent segment allocated at this end, a secondary radiator can be eliminated. This also makes possible a simpler modular construction of the radiator unit.

It has also proven advantageous if the secondary radiator has an illuminated secondary radiator tube section parallel to the center axis.

The secondary radiator tube section has an elongated construction having a longitudinal axis parallel to the center axis. With respect to the longitudinal axis, the secondary radiator emits, in particular, optical radiation in the radial direction. The elongated field irradiated by the secondary radiator can overlap with the irradiation fields of the main radiator on the substrate; it is thus suitable for compensating a non-uniform irradiation of the substrate caused by the arrangement of the main radiator.

For a preferred embodiment, the secondary radiator tube section has a length in the range from 20 mm to 100 mm.

The length of the secondary radiator tube section influences the maximum irradiation intensity that can be achieved with the secondary radiator. A secondary radiator having a length of less than 20 mm can compensate irradiation inhomogeneities on the substrate only to a limited degree. A secondary radiator tube section having a length of more than 100 mm negatively affects the compact construction of the device according to the invention.

Preferably, the main radiator and spot radiator are infrared radiators.

Infrared radiators are used for heating and drying processes; they are suitable, in particular, for shaping materials, such as metals, glass, or thermoplastics.

It has proven effective if the illuminated radiator tube section extends with reference to the center axis over an arc angle in the range from ½π rad to ⅔π rad.

The size of the illuminated radiator tube section of the main radiator influences the homogeneity of the irradiation and the number of segments. Because each segment has a main radiator, for an arc angle in the range mentioned above, three or four segments can be provided. For more than four segments, the energy efficiency of the device and the mechanical stability of the radiator unit can be negatively affected. Preferably, three segments are provided. This has the advantage that, on one hand good energy efficiency is possible and, on the other hand, an opening of the radiator unit in a large range is made possible.

In another advantageous embodiment of the device according to the invention, it is provided that the segments can be controlled independently from each other.

An independent control of the segments makes it possible for the segments to be decoupled completely from each other. In this way, it is possible to replace individual segments with structurally identical segments or to exchange segments by segments with different structures. This contributes to high flexibility with respect to the segments. Due to their individual controllability, the device according to the invention can be easily and quickly adapted to the specified processing conditions.

In addition, by replacing a segment with another main radiator having a different geometrical shape or radiation emission, the emission spectrum of the irradiation device can be easily varied and adjusted overall.

It has proven advantageous if the segments have a cooling unit for cooling the main radiator, wherein the cooling unit comprises a plenum chamber having a side facing the main radiator and a side facing away from the main radiator and that can carry a flow of a cooling fluid, and if means are provided in the plenum chamber for feeding the cooling fluid on the side of the plenum chamber facing the main radiator.

Especially for a compact structural shape of the device, not only the substrate is irradiated, but usually the main radiator and secondary radiator are also heated. To prevent excess heating of the main radiator, a cooling chamber for the indirect cooling of the main radiator is provided. The cooling chamber, however, can also affect the temperature of the secondary radiator.

The segments each have a cooling area and an irradiation area. Preferably, the irradiation area is separated from the cooling area by an essentially unbroken and non-perforated reflector.

The main radiators generate a temperature profile during their operation, wherein their non-illuminated radiator tube sections regularly have a lower temperature than the illuminated radiator tube section. However, the illuminated radiator tube section can also have areas of higher temperature, especially a hot spot. This also generates a corresponding hot spot on the wall of the plenum chamber facing the main radiator. The cooling fluid is directed within the plenum chamber onto this wall, which enables an effective cooling in the area of the hot spot.

It has proven effective if the plenum chamber comprises a cooling air inlet, a cooling air outlet, and a fan arranged in the plenum chamber, and if the means for feeding the cooling fluid is an air deflector plate arranged downstream of the fan.

A fan integrated in the plenum chamber contributes to a compact structural shape of the device.

The cooling air is preferably fed to the hottest area within the plenum chamber. An air deflector plate, for example, is suitable for the cooling air feeding. For another advantageous embodiment of the device according to the invention, it is provided that the main radiator is connected by a fastener to the plenum chamber and the fastener is arranged in the plenum chamber.

Therefore, because the fastener is arranged in the plenum chamber, in comparison to a fastener arranged in the irradiation area, excessive heating is prevented and a conduction of heat via the fastener to the plenum chamber is reduced.

It has proven favorable if the main radiator and the secondary radiator are provided with a reflector.

The reflector reflects light incident on it in the direction of the substrate to be irradiated and contributes to a high energy efficiency of the device.

With respect to the segments for use in a device for irradiating a cylindrical substrate, the object specified above is achieved according to the invention in that it has an optical main radiator having an illuminated radiator tube section that is curved outwardly with respect to the center axis.

The segment according to the invention is suitable for use in the device according to the invention. With respect to advantageous embodiments of the segment, refer to the statements concerning the device according to the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective representation of an embodiment of the device according to the invention for irradiating a substrate with a radiator unit comprising multiple segments;

FIG. 2 is a cross-section of the device shown in FIG. 1;

FIG. 3 is a perspective representation of a segment for use in the device according to FIG. 1, and;

FIG. 4 is a cross-section of the segment shown in FIG. 3.

### DETAILED DESCRIPTION OF THE INVENTION

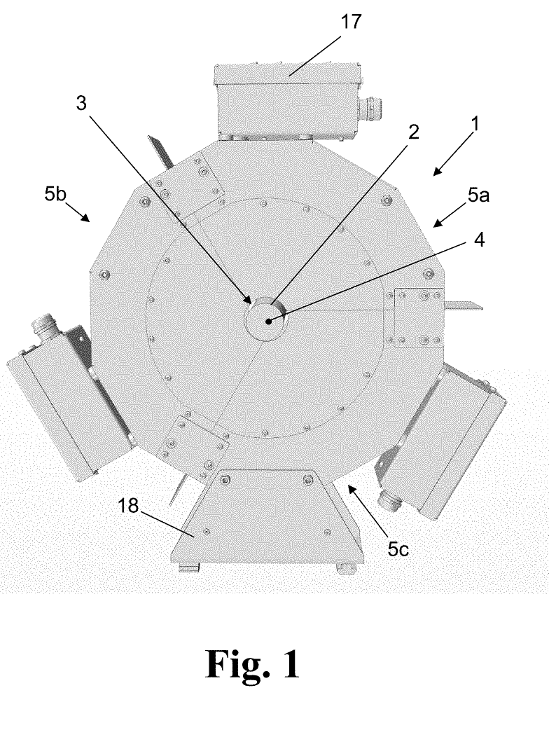

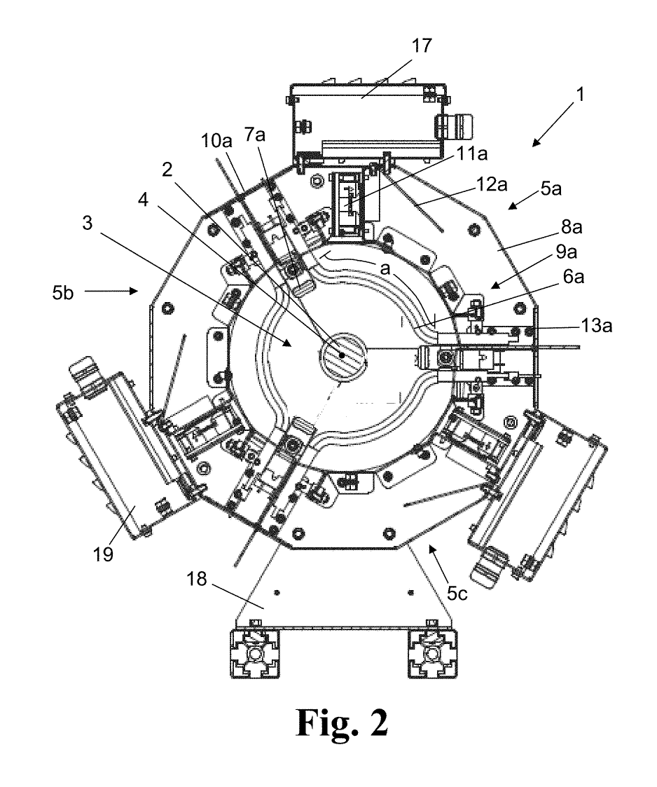

FIG. 1 shows schematically an outer view of an irradiation device according to the invention for irradiating cylindrical substrates 2 and how it is used for the production of pultruded fiber composite profiles. The reference symbol 1 is allocated to the irradiation device overall. It has a cylindrical irradiation chamber 3 having a center axis 4 and a radiator unit that is around the irradiation chamber 3 and to which is allocated the reference symbol 5 overall. The radiator unit 5 is provided with a holding and mounting device 18 and comprises three identical segments 5a, 5b, 5c. Each of the segments 5a, 5b, 5c is provided with a connection box 17 and has a main radiation source, a spot radiator, and a cooling unit. The last-mentioned components will be explained in more detail with reference to the following FIGS. 2 to 4.

In FIG. 2, a cross-sectional representation of the device 1 from FIG. 1 is shown schematically. The device 1 comprises a cylindrical irradiation chamber 3 having a center axis 4. A radiator unit 5 is arranged around the irradiation chamber 3. The radiator unit 5 comprises three structurally identical segments 5a, 5b, 5c, which can be controlled independently from each other. Each of the segments 5a, 5b, 5c has a main infrared radiator, wherein the main infrared radiators are arranged so that their illuminated radiator tube sections are in one plane. The segments 5a, 5b, 5c are identical. The following explanations of segment 5a therefore apply accordingly also for the other segments 5b, 5c.

Segment 5a has an infrared radiator 6a having an illuminated radiator tube section that is marked with “a” in FIG. 2 and is curved outwardly as viewed from the center axis 4 of the irradiation chamber 3. The heated length of the radiator tube section is 144 mm. The infrared radiator 6a is distinguished by a nominal output of 500 W for a rated voltage of 133 V. The outer dimensions of the radiator tube are 23×264 mm.

Segment 5a also has a spot radiator 7a that is allocated, in this view, to the right end of the segment. The spot radiator 7a is an infrared radiator. It has an illuminated spot radiator tube section that runs parallel to the center axis 4 of the irradiation chamber 3. The heated length of the spot radiator tube section is 45 mm. The spot radiator 7a is distinguished by a nominal power of 160 W for a nominal voltage of 60 V. The outer dimensions of the radiator tube are 75×70 mm.

The total power of the radiator unit is thus 1980 W, of which each of the structurally identical segments contributes 660 W.

In addition, the segment 5a has an air cooling unit 8a with a plenum chamber 9a. Cooling air is suctioned in via an inlet 10a by a fan 11a arranged in the plenum chamber 9a and fed with an air deflector plate 12a to the side of the plenum chamber 9a facing the main infrared radiator 6a. In this way, an effective cooling of this side of the plenum chamber 9a is ensured. The suctioned air leaves the plenum chamber 9a via the cooling air outlet 13a. The infrared radiator 6a is connected by two fasteners 14a, 14b to the plenum chamber 9a. The fasteners are arranged in the plenum chamber 9a.

A reflector having an aluminized surface is mounted on the outside of the side of the plenum chamber facing the main infrared radiator 6a.

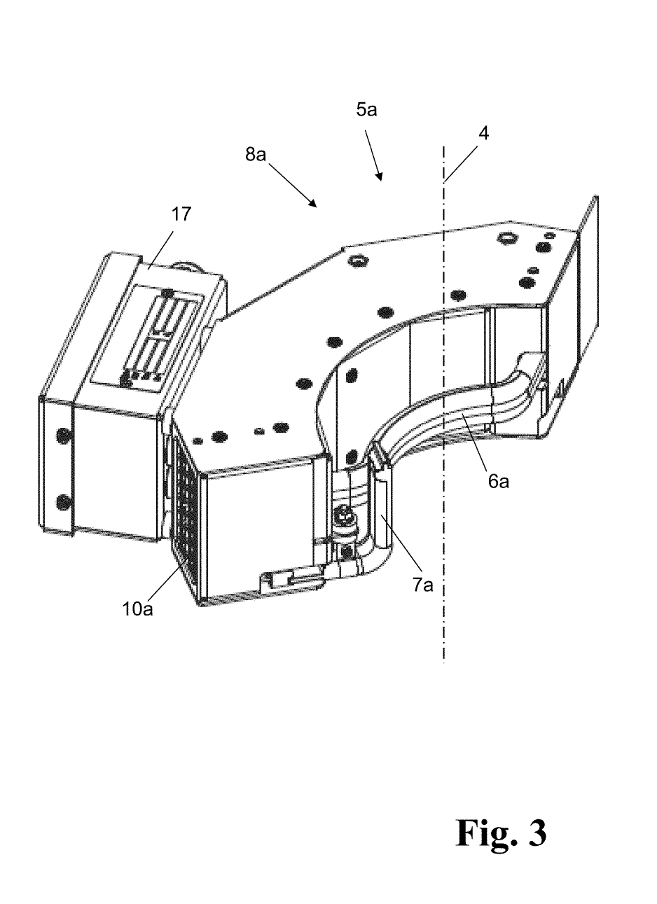

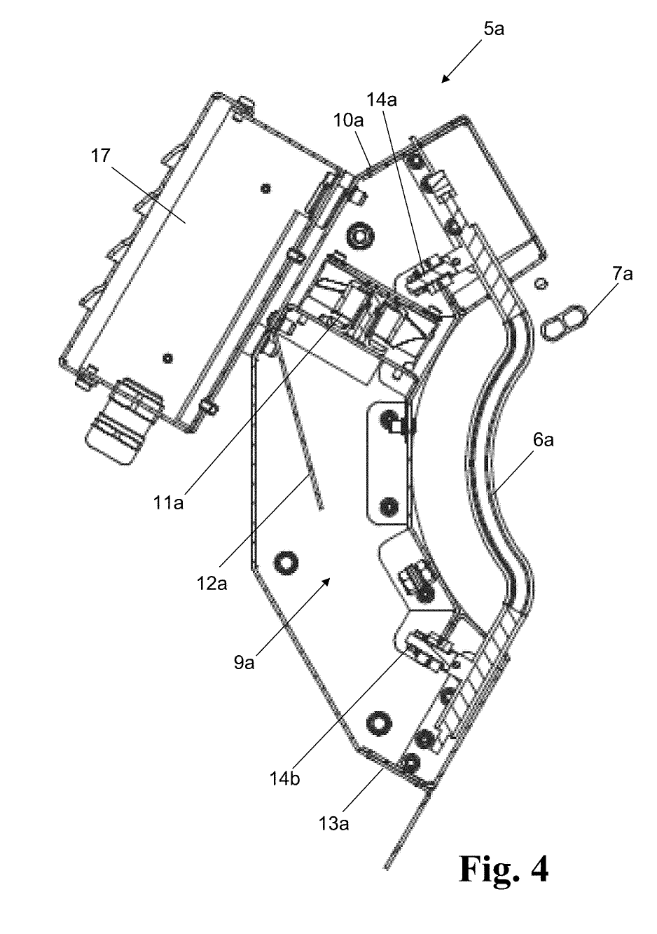

FIGS. 3 and 4 show schematically a perspective view and a top view, respectively, of a segment 5a according to the invention for use in the irradiation device 1 according to FIG. 1. The segment 5a comprises a main infrared radiator 6a, which is connected to the plenum chamber 9a by fasteners 14a, 14b arranged in the plenum chamber 9a. In addition, the segment 5a includes a spot radiator 7a.

The segment 5a further comprises a plenum chamber 9a having a cooling air inlet 10a, a fan 11a, an air deflector plate 12a, and a cooling air outlet 13a.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-13. (canceled)

14. A device for irradiating a cylindrical substrate comprises
a cylindrical irradiation chamber having a center axis; and
a radiator unit around the irradiation chamber, wherein the radiator unit is formed from multiple segments connected to each other, wherein each of the segments has an optical main radiator having an illuminated radiator tube section that is curved outwardly with reference to the center axis, and wherein the radiator tube sections are arranged in a common radiator plane perpendicular to the center axis.

15. The device according to claim 14, wherein an optical secondary radiator is arranged between the illuminated radiator tube sections of adjacent segments.

16. The device according to claim 15, wherein each of the segments has a first and a second end for the detachable connection to an adjacent segment, and the secondary radiator is arranged on the first end.

17. The device according to claim 15, wherein the secondary radiator has a secondary radiator tube section parallel to the center axis.

18. The device according to claim 17, wherein the secondary radiator tube section has a length in a range from 20 mm to 100 mm.

19. The device according to claim 15, wherein the primary radiator and the secondary radiator are infrared radiators.

20. The device according to claim 14, wherein the illuminated radiator tube section extends with reference to the center axis over an arc angle in a range from ½π rad to ⅔π rad.

21. The device according to claim 14, wherein the segments are controllable independently from each other.

22. The device according to claim 14, wherein the segments have a cooling unit for cooling the main radiator, wherein the cooling unit comprises a plenum chamber having one side facing the main radiator and one side facing away from the main radiator and that can carry a flow of cooling fluid, and that means are provided in the plenum chamber for feeding the cooling fluid to the side of the plenum chamber facing the main radiator.

23. The device according to claim 22, wherein the plenum chamber comprises a cooling air inlet, a cooling air outlet, and a fan arranged in the plenum chamber, and that the means for feeding the cooling fluid is an air deflector plate arranged downstream of the fan.

24. The device according to claim 22, wherein the main radiator is connected by a fastener to the plenum chamber and the fastener is arranged in the plenum chamber.

25. The device according to claim 15, wherein the main radiator and the secondary radiator are provided with a reflector.

26. A segment for use in a device for irradiating a cylindrical substrate according to claim 14, wherein the segment has an optical main radiator having an illuminated radiation tube section that is curved outwardly with respect to the center axis.
